(19) United States
(12) Patent Application Publication
(10) Pub. No.: US 2005/0054113 A1
(43) Pub. Date: Mar. 10, 2005

(54) Methods of processing sample processing devices

(76) Inventor: William Bedingham, Woodbury, MN (US)

Correspondence Address: 3M INNOVATIVE PROPERTIES COMPANY, PO BOX 33427, ST. PAUL, MN, 55133-3427, US

(21) Appl. No.: 10/500,584

(22) PCT Filed: Dec. 23, 2002
(86) PCT No.: PCT/US02/40949

(30) Foreign Application Priority Data
Dec. 31, 2001 (US) 60344857

(51) Int. Cl. G01N 1/00

(52) U.S. Cl. 436/174

(57) ABSTRACT

The methods of the present invention may include some or all of the following activities: providing one or more sample processing devices to a user (10); collection of sample materials by the user (20); loading of the sample materials into one or more of the sample processing devices (including, optionally, the loading of reagents with or separate from the sample materials) (30); sealing of the sample processing devices by the user (40); forwarding of the loaded sample processing devices to a processing facility by the user (50); processing of the loaded sample processing devices by the processing facility in accordance with any instructions from the user (60); providing results of the processing to the user by the processing facility (70); and destruction, archival, or return of the processed sample processing devices as desired by the user (80).

### RELATED APPLICATIONS

This application claims the benefit under 35 U.S.C. §119(e) of U.S. Provisional Patent Application Ser. No. 60/344,857 filed on 31 Dec. 2001, which is hereby incorporated by reference in its entirety.

### FIELD OF THE INVENTION

The present invention relates to the field of sample processing devices. More preferably, the present invention relates to the processing of sample processing devices.

### BACKGROUND

The development of methods and techniques for analysis of genomic and proteomic biological materials provides powerful tools for clinical practitioners as well as medical practitioners. In many instances, however, the expertise and/or the equipment required to practice these methods and techniques is not available in a clinical setting. For example, the skill and equipment required to perform a DNA sequencing analysis is simply beyond the skills of a vast majority of clinical practitioners. Furthermore, access to personnel and/or facilities that can perform such analyses is also typically limited.

What is needed is a method that allows the clinical practitioner or other unskilled users access to the advanced methods and techniques of genomic and proteomic analysis of biological materials in a convenient, cost-effective and timely manner.

### SUMMARY OF THE INVENTION

The present invention provides methods of using sample processing devices to process sample materials. The methods of the present invention provide users with the ability to obtain advanced processing of sample materials while not requiring the user to obtain the skills or the equipment required to perform the desired analyses. In other instances, the methods of the present invention can offer users the ability to focus their efforts on other activities.

The present invention takes advantage of recent advances in sample processing devices, especially in disposable sample processing devices that can be used to perform, e.g., genomic analyses such as polymerase chain reaction (PCR), Sanger sequencing, etc.

Furthermore, the sealed nature of the sample processing devices used in connection with the present invention provides advantages because in many instances the sample materials are not transferred between containers or devices during processing, instead remaining within the confines of the sample processing devices into which they were loaded by the user. That sealed nature may, for example, provide protection by reducing the likelihood that viruses or other pathogens included in the sample materials can escape from the sample processing devices. In addition, many, if not all, of the processes performed on the sample materials loaded in the sample processing devices are automated. Automation can be useful in reducing the variability inherent in manual processes, it may also provide additional control over cross-contamination of sample materials contained in other sample processing devices.

In one aspect, the methods of the present invention include some or all of the following activities: providing one or more sample processing devices to a user; collection of sample materials by the user; loading of the sample materials into one or more of the sample processing devices (including, optionally, the loading of reagents with or separate from the sample materials); sealing of the sample processing devices by the user; forwarding of the loaded sample processing devices to a processing facility by the user; processing of the loaded sample processing devices by the processing facility in accordance with any instructions from the user; providing results of the processing to the user by the processing facility; and destruction, archival, or return of the processed sample processing devices as desired by the user.

In other aspects, the present invention may provide a method of using a sample processing device, the method including loading biological sample material into a sample processing device by a user; sealing of the biological sample material in the sample processing device; shipping the sample processing device to a processing facility after sealing the sample processing device; processing the biological sample material in the sample processing device at the processing facility; and communicating results of the processing to the user.

In various other embodiments, the methods may also involve loading a reagent into the sample processing device before sealing of the sample processing device by the user and/or loading a reagent into the sealed sample processing device at the processing facility.

The methods may optionally include processing the biological sample material by performing genomic analysis of the biological sample material; performing polymerase chain reaction processing of the biological sample material; performing Sanger sequencing processing of the biological sample material; performing electrophoretic separation, etc.

The methods may further include archiving of the sample process device containing the biological sample material after processing the biological sample material at the processing facility and communicating the results to the user.

The methods may also include shipping the sample process device containing the biological sample material to the user after processing the biological sample material at the processing facility.

Optionally, the methods of the present invention may include collection of the biological sample material by the user before loading the sample processing device with the biological sample material. In another option, the method may include collection of the biological sample material by the user and combining of a reagent with the biological sample material before loading the biological sample material into the sample processing device.

In still other methods, the sealing may include placing a tamper-evident seal on the sample processing device and/or placing a seal including pressure sensitive adhesive on the sample processing device.

These and other features and advantages of the invention may be described below in connection with illustrative embodiments of the invention.

### BRIEF DESCRIPTION OF THE DRAWINGS

FIG. 1 is a flow diagram of one illustrative method of the present invention.

### DETAILED DESCRIPTION OF ILLUSTRATIVE EMBODIMENTS OF THE INVENTION

The sample processing devices used in connection with the methods of the present invention may preferably be designed for processing sample materials that include biological material such as peptide- and/or nucleotide-containing material. Examples of some sample processing devices and methods of using them that may be used in connection with the methods of the present invention include those devices described in, e.g., commonly-assigned U.S. patent application Ser. No. 09/894,810, filed on Jun. 28, 2001 and entitled ENHANCED SAMPLE PROCESSING DEVICES SYSTEMS AND METHODS and U.S. patent application Ser. No. 09/895,010, filed on Jun. 28, 2001 and entitled SAMPLE PROCESSING DEVICES. Other useable device constructions may be found in, e.g., U.S. Provisional Patent Application Ser. No. 60/214,508 filed on Jun. 28, 2000 and entitled THERMAL PROCESSING DEVICES AND METHODS; U.S. Provisional Patent Application Ser. No. 60/214,642 filed on Jun. 28, 2000 and entitled SAMPLE PROCESSING DEVICES, SYSTEMS AND METHODS; U.S. Provisional Patent Application Ser. No. 60/237,072 filed on Oct. 2, 2000 and entitled SAMPLE PROCESSING DEVICES, SYSTEMS AND METHODS; U.S. Provisional Patent Application Ser. No. 60/260,063 filed on Jan. 6, 2001 and entitled SAMPLE PROCESSING DEVICES, SYSTEMS AND METHODS; U.S. Provisional Patent Application Ser. No. 60/284,637 filed on Apr. 18, 2001 and entitled ENHANCED SAMPLE PROCESSING DEVICES, SYSTEMS AND METHODS; U.S. patent application Ser. No. 09/837,073, filed on Apr. 18, 2001 and entitled MULTI-FORMAT SAMPLE PROCESSING DEVICES, METHODS AND SYSTEMS (Attorney Docket No. 56545USA4A.003); and U.S. Patent Application Publication No. US 2002/0048533 A1 filed Jun. 28, 2001 and entitled SAMPLE PROCESSING DEVICES AND CARRIERS. Additional clean-up and/or removal materials and other features may be found in, e.g., U.S. patent application Ser. No. 10/027,226 filed Dec. 20, 2001 and entitled METHODS AND DEVICES FOR REMOVAL OF ORGANIC MOLECULES FROM BIOLOGICAL MIXTURES USING A HYDROPHILIC SOLID SUPPORT IN A HYDROPHOBIC MATRIX (Attorney Docket No. 57313US002) and in U.S. patent application Ser. No. 10/027,222 filed Dec. 20, 2001 and entitled METHODS AND DEVICES FOR REMOVAL OF ORGANIC MOLECULES FROM BIOLOGICAL MIXTURES USING ANION EXCHANGE (Attorney Docket No. 57314US002). Other devices and methods are described in U.S. patent application Ser. No. 10/034,334 filed Dec. 28, 2001 and entitled SAMPLE PROCESSING DEVICE WITH INTEGRAL ELECTROPHORETIC CHANNELS (Attorney Docket No. 56544US002).

In addition to the devices described in these commonly-assigned patent applications, the methods of the present invention may also be performed using other devices and processing methods. Examples of some suitable sample processing devices may be described in, e.g., International Publication Nos. WO 97/36681 (Woudenberg et al.); WO 98/22625 (Burns et al.); WO 98/45481 (Knapp et al.); WO 99/43432 (Dubrow et al.); WO 00/05582 (Virtanen); WO 00/40750 (Orlefors et al.); WO 01/47638 (Tooke et al.); as well as in U.S. Pat. No. 5,229,297 (Schnipelsky et al.); U.S. Pat. No. 5,304,487 (Wilding et al.); U.S. Pat. No. 5,585,069 (Zanzucchi et al.); U.S. Pat. No. 5,587,128 (Wilding et al.); U.S. Pat. No. 5,639,428 (Cottingham); U.S. Pat. No. 6,030,581 (Virtanen); U.S. Pat. No. 6,126,899 (Woudenberg et al.); U.S. Pat. No. 6,123,798 (Gandhi et al.); and U.S. Pat. No. 6,319,469 B1 (Mian et al.).

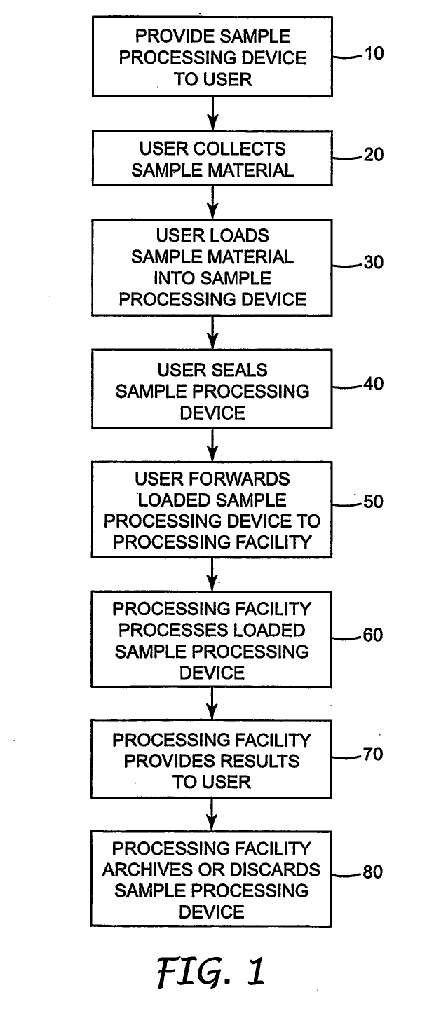

FIG. 1 is a flow diagram of one illustrative method according to the present invention. It will be understood that the depicted method is illustrative in nature only and includes a number of optional steps that may or may not be included within the scope of the present invention as it may be most broadly defined.

The initial step 10 in the flow chart includes providing one or more sample processing devices to a user for receiving sample materials. The sample processing devices may, e.g., be manufactured according to the principles and teachings of any of the above-identified patent documents. Further, the user may be supplied with different sample processing devices so that they have the opportunity to select the device or devices most appropriate for the analyses they desire to have performed. Further, the sample processing devices may be preloaded with various reagents or other materials as discussed in many of the above-identified patent documents.

The next step 20 in the depicted method involves collection of a sample containing biological material by the user. The sample may be obtained by any suitable technique and may constitute any type of biological material (as described above). Examples of some exemplary samples containing biological material include blood, etc. Depending on the capabilities of the sample processing devices into which the sample is to be loaded, the actual collected sample may be processed by the user into a form appropriate for analysis on the sample processing device. For example, it may be desirable to combine the sample with a desired reagent or reagents (e.g., PCR primers, etc.). In other instances, it may be desirable for the user to perform additional pre-loading processes to put the sample into shape for analysis on the sample processing device.

After collecting the sample material, the next step 30 in the depicted method involves loading of the sample material into one or more of the sample processing devices. The loading may be performed into more than one sample processing device where, e.g., different analyses are desired that are performed on different sample processing devices, verification of the integrity of the results is desired (by providing redundant testing on different sample processing devices), etc. The loading may be accomplished by hand or by automated processes and equipment (or a combination of both). Furthermore, the loading of sample materials may be accompanied by loading of reagents (e.g., PCR primers, etc.) into the same or different chambers on the sample processing devices.

After loading the sample processing devices, the next step 40 includes sealing of the sample processing device by the user to prevent leakage, evaporation, and/or cross-contamination between different sample processing devices. The seals may preferably be tamper-evident to ensure integrity of the results. Any suitable sealing techniques may be used although it may be preferred to use a pressure-sensitive adhesive coated cover tape for ease of use.

If a pressure sensitive adhesive seal is to be used, it may be preferred that the pressure sensitive adhesive be disposed on a backing (preferably, a backing that is transparent to electromagnetic energy of selected wavelengths). The adhesive is preferably selected such that it adheres well to materials of which the sample processing devices are made (e.g., polyolefins, polystyrene, polycarbonate, or combinations thereof), maintains adhesion during high and low temperature storage (e.g., about −80° C. to about 150° C.) while providing an effective seal against sample evaporation, does not substantially dissolve in or otherwise react with the components of the sample materials or reagents. Thus, the type of adhesive is not critical as long as it does not interfere (e.g., bind DNA, dissolve, etc.) with any processes performed in the sample processing device. Preferred adhesives include those typically used on cover films of analytical devices in which biological reactions are carried out. These include poly-alpha olefins and silicones, for example, as described in International Publication Nos. WO 00/45180 (Ko et al.) and WO 00/68336 (Ko et al.).

Following sealing of the sample processing device, the next step 50 in the method involves forwarding of the loaded sample processing devices to a processing facility that has the equipment and personnel required to perform the desired analyses on the sample materials loaded into the sample processing devices. The sample processing devices may be shipped or transported by any suitable carrier, e.g. courier, mail, etc. The loaded sample processing devices may be packaged in any suitable container depending on the nature of the sample materials, the requirements of the carrier, etc.

Upon receipt of the loaded sample processing devices, the next step 60 in the method involves processing of the loaded sample processing devices by the processing facility according to the instructions received from the user and/or the nature of the sample processing devices. Examples of some suitable processes that may be performed include, e.g., PCR amplification, Sanger sequencing, electrophoretic separations, etc. The processing may include the introduction of one or more desired reagents into the sample processing devices at the processing facility. This may be useful where, e.g., reagents are unavailable to the user who loaded the sample materials into the sample processing devices, the reagents are not stable enough to withstand shipment, etc.

After processing in the processing facility, the next step 70 involves communicating the results of the various analyses to the user who loaded the sample processing devices and provided them to the processing facility. Communication of the test results to the user may be by any suitable technique, e.g., voice (e.g., telephone), in person, mail, electronic mail, Internet-based communication, etc. The information communicated may include images and/or other information in addition to or in place of alpha-numeric data.

Another optional step 80 in the depicted method involves handling of the sample processing devices after processing by the processing facility. In some instances, the user may request that the sample processing devices be destroyed after processing and collection of the data generated as a result of the processing. In other instances, the user may request that the processing facility retain and archive the sample processing devices to allow for, e.g., later verification of the results of the processing. In other instances, the user may request that the sample processing devices be returned after processing, with the user arranging for destruction or archiving of the processed devices.

Patents, patent applications, and publications disclosed herein are hereby incorporated by reference (in their entirety) as if individually incorporated. It is to be understood that the above description is intended to be illustrative, and not restrictive. Various modifications and alterations of this invention will become apparent to those skilled in the art from the foregoing description without departing from the scope of this invention, and it should be understood that this invention is not to be unduly limited to the illustrative embodiments set forth herein.

1. A method of using a sample processing device, the method comprising:
loading biological sample material into a sample processing device by a user;
sealing of the biological sample material in the sample processing device;
shipping the sample processing device to a processing facility after sealing the sample processing device;
processing the biological sample material in the sample processing device at the processing facility; and
communicating results of the processing to the user.

2. A method according to claim 1, further comprising loading a reagent into the sample processing device before sealing of the sample processing device by the user.

3. A method according to claim 1, further comprising loading a reagent into the sealed sample processing device at the processing facility.

4. A method according to claim 1, wherein processing the biological sample material comprises genomic analysis of the biological sample material.

5. A method according to claim 1, wherein processing the biological sample material comprises polymerase chain reaction processing of the biological sample material.

6. A method according to claim 1, wherein processing the biological sample material comprises Sanger sequencing processing of the biological sample material.

7. A method according to claim 1, wherein processing the biological sample material comprises electrophoretic separation.

8. A method according to claim 1, further comprising archiving of the sample process device containing the biological sample material after processing the biological sample material at the processing facility and communicating the results to the user.

9. A method according to claim 1, further comprising shipping the sample process device containing the biological sample material to the user after processing the biological sample material at the processing facility.

10. A method according to claim 1, further comprising collection of the biological sample material by the user before loading the sample processing device with the biological sample material.

11. A method according to claim 1, further comprising collection of the biological sample material by the user and combining of a reagent with the biological sample material before loading the biological sample material into the sample processing device.

12. A method according to claim 1, wherein the sealing comprises placing a tamper-evident seal on the sample processing device.

13. A method according to claim 1, wherein the sealing comprises placing a seal that comprises pressure sensitive adhesive on the sample processing device.
